(19) United States
(12) Patent Application Publication
(10) Pub. No.: US 2007/0128374 A1
(43) Pub. Date: Jun. 7, 2007

(54) Paint product and method of manufacture

(76) Inventor: Mark Andrew Rowen, Yinnar (AU)

Correspondence Address: BROOKS KUSHMAN P.C., 1000 TOWN CENTER, TWENTY-SECOND FLOOR, SOUTHFIELD, MI, 48075, US

(21) Appl. No.: 10/595,803

(22) PCT Filed: Nov. 10, 2004
(86) PCT No.: PCT/AU04/01551

§ 371 Date: May 12, 2006

(30) Foreign Application Priority Data
Sep. 23, 2004 (AU) 2004905458
Nov. 13, 2003 (AU) 2003906247

(51) Int. Cl. B05D 3/00

(52) U.S. Cl. 427/444

(57) ABSTRACT

The present invention discloses a new paint coating product produced by the combination of paint residue separated from a waste stream of wash solvents and combined with a hardening agent and other additives as desired for specific applications. The present invention also discloses a process of producing a surface coating wherein the paint residue is derived from a waste stream of wash solvents by the process of distillation.

### FIELD OF INVENTION

The present invention relates to the field of paint and paint manufacture. In one aspect, the present invention relates to recycling of paint residues. It will be convenient to hereinafter describe the invention in relation to the use of paint residues, however it should be appreciated that the present invention is not limited to that use only.

### BACKGROUND ART

In many industrial settings, surface coatings (paints) are used to provide protective and decorative finishes to a wide variety of substrates. Often paints are solvent based and applied by a spray system. When spray equipment is cleaned of paint with wash solvents, a waste stream consisting of paint and wash solvent is created.

Wash solvents are typically recycled by distillation of waste streams to yield fresh wash solvent and separated paint residues. Paint residues are solids of resin and pigments that if not correctly disposed of, cause damage to the natural environment. The disposal of paint pigments is highly regulated, (in Victoria, Australia the competent authority is the Environment Protection Authority (EPA) which controls the disposal of these substances at licensed landfills, after meeting various test requirements). The production of such waste streams, which must be treated and disposed of at high cost, is a problem in the field of paint production and its application.

The above discussion and any other discussion of documents, devices, acts or knowledge in this specification are included to explain the context of the invention. It should not be taken as an admission that any of the material forms a part of the prior art base or the common general knowledge. In the relevant art in Australia or elsewhere on or before the priority date of the disclosure and claims herein.

An object of the present invention is to provide for a process and/or a coating that uses recycled paint residues.

A further object of the present invention is to at least alleviate or overcome at least one disadvantage associated with the prior art.

### SUMMARY OF INVENTION

The present invention provides a process for producing and/or a coating for surfaces, comprising a paint residue extracted from a paint waste stream and a hardener, wherein said residue and hardener are combined for application on a substrate.

In a preferred aspect, the invention provides for a coating for surfaces wherein the hardener is an isocyanate.

In a further preferred aspect, the invention provides for a coating for surfaces wherein the isocyanate is hexamethylene diisocyanate (HDI) or toluene diisocyanate (TDI) or 4,4′-diphenylmethane dilsocyanate (MDI) or isophorone dilsocyanate or the pre-polymers, oligomers, adducts derived therefrom.

Other aspects and preferred aspects are disclosed in the specification and/or defined in the appended claims, forming a part of the description of the invention.

In essence, the inventor has identified a new coating product that stems from the realisation that waste paint residue can be separated from wash solvents and combined with a further agent to produce a surface coating that is useable for use in new applications.

The present invention has been found to result in a number of advantages, such as recycling of otherwise waste material, and a reduction in the tonnage of valuable raw material going to landfill. Further benefits include greenhouse gas reduction and economic savings to industry.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Further disclosure, objects, advantages and aspects of the present application may be better understood by those skilled in the relevant art by reference to the following description of preferred embodiments which are given by way of illustration only, and thus are not limitative of the present invention, and in which:

### DETAILED DESCRIPTION

Source and Selection of Raw Material

The raw material used as a base to manufacture the recycled surface coating is a waste wash stream sourced from industrial trades that use new paint of different types. Each trade typically uses a wash solvent to clean equipment, with commercially available solvents used to adjust the viscosity of the paint mixture to achieve the desired spraying viscosity. The resulting waste wash stream contains wash solvent and paint residues comprising colour pigments and a resin. An example source of a waste stream is the auto refinishing trade, however the invention is not limited in any way to the source or type of consistent wash stream used. Further possible sources may for example include food can producers using epoxy and polyester surface coating and flexographic printers using inks. Depending on the source of the waste stream, it is necessary that it is a liquid of a low viscosity and does not contain large amounts of gelled paint.

Paint Making Process

The waste wash stream is placed in a still apparatus to vaporise, condense and therefore separate away the volatile wash solvent, which is itself then re-useable. Heat is applied to the still to raise its temperature to the initial boiling point of the wash stream (being approximately 75-80° C. for auto refinish wash solvent). As distillation proceeds, the still temperature gradually rises to the final boiling point (being >150° C. for auto refinish wash solvent). Other wash streams exhibit differing initial and final boiling points depending upon the actual solvent formulation in use. Heat to the still is then terminated and the contents gravity unloaded into a suitable container and allowed to cool. The still contents are liquid at the unloading temperature and cools to a highly viscous liquid at ambient temperature.

The hydroxyl content of residues is measured and the cooled resin/pigment mix is thinned with 25-30% volume of the original solvent. The residue is comprised of at least basecoat colours and a resin, the resin of which may be separated if desired. The resin has a chemical characteristic to allow cross linking after it dries due to the evaporation of the solvent component of the mix. The resin of the paint residue is capable of reacting with a hardener to form a useable surface coating, thus the thinned mixture is then further mixed with a common ambient cure hardener such as isocyanate. The preferred isocyanate is hexamethylene di-isocyanate (HDI) or toluene di-isocyanate (TDI) or 4,4′-diphenylmethane dilsocyanate (MDI) or isophorone diisocyanate. Given the chemical nature of the residues, other hardening mechanisms may be used, such as an amine cure.

The amount of hardener determines the desired cross linking ratio. The cross linking reaction can be formulated anywhere in the range 0% cross linked (no hardener) to 100% cross linked, which is preferable in resulting in a very high quality paint finish.

The resultant combination of residue and hardener produces a coating that will remain in a fluid state for a limited time known as ‘pot life’, during which time the coating may be applied to a desired substrate. Pot life is in the order of 6 hours at 20° C., but varies with a number of parameters, most notably temperature.

Further Treatment of the Paint Residue

The basic resin and pigment mixture of the residue may undergo further treatment by separation according to the specific gravities of each component. Precise colour matches cannot be obtained using the residues, processed as described. However it is well known in the art that upon standing, paints will settle out with the heavy pigments falling to the bottom and the clear resin solution sitting on top. This process can be accelerated using an industrial decanter or centrifuge. These machines subject a liquid to high speed rotation resulting in high G forces (8000 G for decanter, 13000 G for centrifuge). Thus the heavy pigment can readily be separated from the washings prior to distillation, yielding a clear resin upon processing. This resin is thinned and retinted to the desired colour.

Further Additives

Other additives, such as accelerators, can be used in formulation to enhance or alter the coating film properties. Accelerators for the hydroxyl-isocyanate reaction are widely available to the coatings industry, with well documented effects.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.”

1. A coating for surfaces, comprising:
a paint residue extracted from a paint waste stream; and
a hardener;
wherein said residue and hardener are combined for application on a substrate.

2. The coating as claimed in claim 1, wherein said hardener is an isocyanate.

3. The coating as claimed in claim 2, wherein said isocyanate is hexamethylene di-isocyanate (HDI) or toluene di-isocyanate (TDI) or 4,4′-diphenylmethane diisocyanate (MDI) or isophorone diisocyanate the pre-polymers, oligomers or adducts derived therefrom.

4. The coating as claimed in claim 3, wherein the MDI is mixture of:
4,4′-diphenylmethane diisocyanate substantially 30-60% by weight and Polymethylene polyphenyl isocyanate substantially 30-60% by weight.

5. A process for producing a surface coating, comprising:
placing a paint waste stream in a still;
thereafter operating said still and separating wash solvent from paint residue;
thereafter extracting paint residue from said still;
thereafter diluting paint residue to a workable viscosity;
thereafter combining said diluted residue with a hardening agent to form a useable surface coating.

6. The process of claim 4, wherein the diluted residue is combined with enough hardener to fully react with the reactive sites of the residue.

7. The process of claim 4, wherein diluted residue is combined with hardener in stoichiometric amounts (based upon functional group analysis).

8. The process of claim 4, wherein said residue is purified according to specific gravity of its components, before combining with said hardening agents and pigments of desired colour.

9. The process of claim 5, wherein said residue is purified according to specific gravity of its components, before combining with said hardening agents and pigments of desired colour.
